(19) United States
(12) Patent Application Publication
(10) Pub. No.: US 2023/0112065 A1
(43) Pub. Date: Apr. 13, 2023

(54) SERVER AND METHOD FOR PROVIDING IN-KIND ADVERTISEMENT PLATFORM

(71) Applicant: Chul Ho KIM, Seoul (KR)

(72) Inventor: Chul Ho KIM, Seoul (KR)

(21) Appl. No.: 17/904,952

(22) PCT Filed: Aug. 20, 2020
(86) PCT No.: PCT/KR2020/011116

§ 371 Date: Aug. 24, 2022

(30) Foreign Application Priority Data
Mar. 10, 2020 (KR) 10-2020-0029623

(51) Int. Cl. G06Q 30/0214; G06Q 30/0241; G06Q 30/0226

(52) U.S. Cl. CPC G06Q 30/0214; G06Q 30/0226; G06Q 30/0277

(57) ABSTRACT

The present invention relates to a server and method for providing an in-kind advertising platform. According to an embodiment of the present invention, proposed is a method for providing an advertising platform service, the method comprising the steps of: receiving, by a server, information indicating that the spot goods sent from a first user have been obtained; producing and outputting, by the server, information guiding a first addition point corresponding to the spot goods; and allowing, by the server, the first addition point to be added to a first point of the first user if the spot goods are sold to a second user.

### TECHNICAL FIELD

The present invention relates to a server and method for providing a spot advertising platform, and more specifically, to a server and method for providing an advertising platform based on a spot transaction.

### BACKGROUND ART

An advertising platform device and a method for operating the same are disclosed in Korean Patent Application Laid-open No. 10-2016-0094774 (Dated Aug. 10, 2016).

The above-mentioned conventional advertising platform device includes: a providing part for providing an advertisement in an application to a terminal device; a receiving part for receiving service usage history information from a service device related to the advertisement in the application; and a selecting part for selecting the advertisement in the application if it is checked that the service usage history information is generated from the terminal device accessed to the service device through the selection of the advertisement in the application, to provide the selected advertisement to the terminal device based on the service usage history information.

### DISCLOSURE

### Technical Problem

Accordingly, the present invention has been made in view of the above-mentioned problems occurring in the related art, and it is an object of the present invention to provide a server and method for providing a spot advertising platform.

The technical problems to be achieved through the present invention are not limited as mentioned above, and other technical problems not mentioned herein will be obviously understood by one of ordinary skill in the art through the following description.

### Technical Solution

To accomplish the above-mentioned objects, according to one aspect of the present invention, there is provided a method for providing an advertising platform service, the method including the steps of: receiving, by a server, information indicating that the spot goods sent from a first user have been obtained; producing and outputting, by the server, information guiding a first addition point corresponding to the spot goods; and allowing, by the server, the first addition point to be added to a first point of the first user if the spot goods are sold to a second user.

The server receives an advertisement request message for requesting the exposure of a first user advertisement of the first user from a first terminal of the first user and outputs the first user advertisement through at least one of web and application operating by the server in response to the advertisement request message.

The first user advertisement is outputted through a third terminal of at least one third user, and according to the number of first user advertisement outputs by the third terminal, the first point is subtracted, while a third point of the at least one third user is added.

According to the number of first user advertisement outputs by the third terminal, the first point is subtracted by a second subtraction point, the third point is added by a second addition point, and the second subtraction point is larger than the second addition point.

Through the first terminal of the first user, a point threshold value is set.

If the first point is lower than the point threshold value, outputting the first user advertisement through the third terminal is stopped by the server.

The first user advertisement represents the first user, the group of the first user, the company operating by the first user, the sales products of the first user, and the services provided by the first user.

To accomplish the above-mentioned objects, according to another aspect of the present invention, there is provided a system for providing an advertising platform service, the system including a server for managing an advertising platform for providing the advertising platform service and having a control module and a communication module, wherein the control module receives information indicating that the spot goods sent from a first user have been obtained, produces and outputs information guiding a first addition point corresponding to the spot goods, and allows the first addition point to be added to a first point of the first user if the spot goods are sold to a second user.

The communication module receives an advertisement request message for requesting the exposure of a first user advertisement of the first user from a first terminal of the first user and outputs the first user advertisement through at least one of web and application operating by the server in response to the advertisement request message.

The first user advertisement is outputted through a third terminal of at least one third user, and according to the number of first user advertisement outputs by the third terminal, the first point is subtracted, while a third point of the at least one third user is added.

Through the first terminal of the first user, a point threshold value is set, and the control module stops outputting the first user advertisement through the third terminal if the first point is lower than the point threshold value.

### Advantageous Effects

According to the present invention, the server and method can provide enhanced and smart spot advertising platform, thereby having excellent technical effectiveness.

Also, the server and method for providing the advertising platform service according to the present invention can allow those who do not have any capital such as cash but desire to provide advertisements to perform their advertisement through the spot transaction.

The effectiveness of the invention is not limited as mentioned above, and it should be understood to those skilled in the art that the effectiveness of the invention may include another effectiveness as not mentioned above from the detailed description of the present invention.

### BRIEF DESCRIPTION OF DRAWINGS

Objects, characteristics and advantages of the present invention will be more clearly understood from the detailed description as will be described below and the attached drawings.

FIG. 1 is a block diagram showing an advertising platform service system according to an embodiment of the present invention.

FIG. 2 is a flowchart showing a method for providing an advertising platform service according to an embodiment of the present invention.

FIG. 3 is a flowchart showing a method for providing an advertising platform service according to another embodiment of the present invention.

FIG. 4 is a flowchart showing a method for providing an advertising platform service according to yet another embodiment of the present invention.

FIG. 5 is a block diagram showing a control module of an advertising platform management server according to the present invention.

FIG. 6 is an exemplary view showing a web and/or application supporting the advertising platform service according to the present invention.

It should be noted that in the drawings, the corresponding parts in the embodiments of the present invention are indicated by corresponding reference numerals.

### MODE FOR INVENTION

Hereinafter, the present invention is disclosed in detail with reference to the attached drawings.

If it is determined that the detailed explanation on the well-known technology related to the present invention makes the scope of the present invention not clear, the explanation will be avoided for the brevity of the description. This is to explain the scope of the present invention more obviously.

In the description, the thicknesses of the lines or the sizes of the components shown in the drawing may be magnified for the clarity and convenience of the description. Further, the parts corresponding to those of the drawings are indicated by corresponding reference numerals.

Objects, characteristics and advantages of the present invention will be more clearly understood from the detailed description as will be described below and the attached drawings. Before the present invention is disclosed and described, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. In the description, it should be noted that the parts corresponding to those of the drawings are indicated by corresponding reference numerals.

In this case, it will be understood that blocks of the flowcharts in the drawings and the combinations of the flowcharts may be executed by computer program instructions. The computer program instructions are mounted on a processor of a general-purpose computer, a specific computer, or other programmable data processing equipment, and accordingly, the instructions executed through the processor of the computer or other programmable data processing equipment may generate means for performing the functions explained in the blocks of the flowcharts. The computer program instructions may be stored in a computer available or readable memory for a computer or other programmable data processing equipment so as to perform the functions in a specific manner, and accordingly, it is possible that the instructions stored in the computer available or readable memory may produce a manufacturing item having instruction means for performing the functions explained in the blocks of the flowcharts. The computer program instructions may be mounted on a computer or other programmable data processing equipment, and accordingly, a series of operating steps are performed on the computer or other programmable data processing equipment to produce the process executed by the computer so that it is possible that the instructions provide the steps for performing the functions explained in the blocks of the flowcharts.

Further, each block may represent a module, segment, or a portion of a code having one or more executable instructions for performing specific logical function (s). It should be noted that in some replaceable examples, it is possible that the functions mentioned in the blocks may occur, while escaping from their order. For example, the functions in the two blocks shown sequentially may be simultaneously performed, and otherwise, they may be reversely performed sometimes.

In this case, the term ‘part’ , as used herein may be used to describe software or a hardware component such as field-programmable gate array (FPGA) or application specific integrated circuit (ASIC), and serve to perform given functions. However, the term ‘part’ is not limited to the software or hardware component. The term ‘part’ may be configured to be in a storage medium addressable or to play one or more processors. Accordingly, for example, the term ‘part’ may include components such as software components, object-oriented software components, class components, and task components, processes, functions, attributes, procedures, sub-routines, segments of program codes, drivers, firmware, microcodes, circuits, data, database, data structures, tables, arrays, and variables. The functions provided by the components and the parts may be combined to those provided by smaller components and parts or separated into additional components or parts. In addition, the components and parts may be implemented to play one or more CPUs in a device or secure multimedia card.

In explaining the embodiments of the present invention in detail, an example of a specific system will be suggested, but the main subjects to be claimed in the present invention may be applicable even to other communication systems and services having a similar technical background to that in the present invention within the scope as disclosed in the present invention, which is possible under the determination of those skilled in the art.

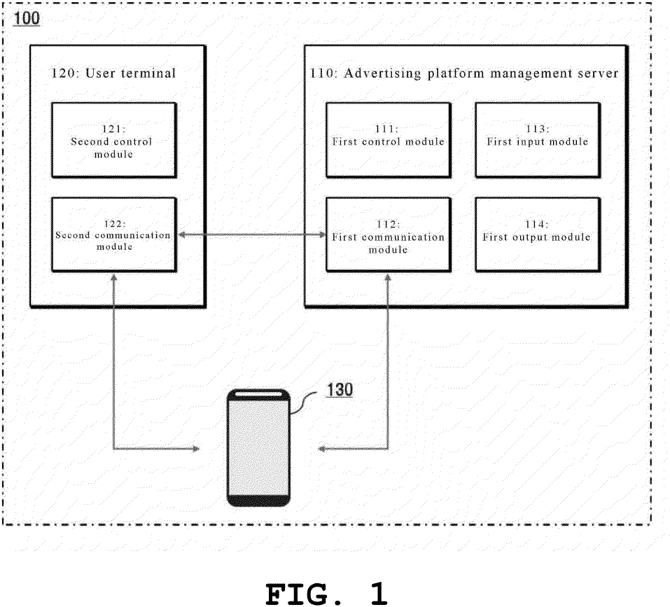

FIG. 1 is a block diagram showing an advertising platform service system according to an embodiment of the present invention.

Referring to FIG. 1, the present invention provides an advertising platform management server 110 for controlling or monitoring an advertising platform service system 100 based on spot goods and/or spot transaction, and the advertising platform service system 100 includes the advertising platform management server 110, a user terminal 120, and/or another user terminal 130.

In this case, the advertising platform management server 110 may be a server system including a web server, a web application server, a database server, and the like, and it may operate in a Windows operating system, Macintosh operating system (MacOS), Java, UNIX, and LINUX or in other various operating systems. Further, the advertising platform management server 110 provides contents related to advertisements to a user free of charge and/or not free of charge.

In this case, the advertising platform management server 110 provides an advertising platform service to the user terminal 120 and/or another user terminal 130, based on a web page or application. Further, the advertising platform service system 100 may represent only the advertising platform management server 110 among the components as shown in FIG. 1.

In this case, the user terminal 120 and/or another user terminal 130 may be communicable computing devices that are used by users who desire to receive the advertising platform service from the advertising platform management server 110. For example, desktop computers, laptops, smart pads, smartphones, and the like may be provided as the user terminal 120 and/or another user terminal 130.

Further, the advertising platform management server 110 includes a first control module 111, a first communication module 112, a first input module 113, and/or a first output module 114, and the user terminal 120 includes a second control module 121, a second communication module 122, a second input module 123 (not shown), and a second output module 124 (not shown).

The control modules 111 and 121 serve to control the advertising platform management server 110 and/or the user terminal 120 directly/indirectly to implement operations/steps/processes according to the present invention. Further, the control modules 111 and 121 include at least one processor, respectively, and the processor includes at least one central processing unit (CPU) and/or at least one graphic processing unit (GPU).

The communication modules 112 and 122 serve to transmit and receive all kinds of data, signals, and information to and from the advertising platform management server 110 and/or the user terminal 120. Further, the communication modules 112 and 122 include wireless communication modules (e.g., cellular communication modules, near field communication modules, or Global Navigation Satellite System (GNSS) communication modules) or wired communication modules (e.g., Local Area Network (LAN) communication modules, or power line communication modules). Besides, the communication modules 112 and 122 are communicable with external electronic devices through wide area networks such as a first network (e.g., Bluetooth, WiFi direct or near field communication network such as infrared data association (IrDA)) or a second network (e.g., cellular network, internet, or wide area communication network such as computer network (e.g., LAN or WAN). Such various kinds of communication modules are integrated with one another as a single component (e.g., a single chip), and otherwise, they may be provided as a plurality of components (e.g., a plurality of chips).

Moreover, the communication modules 112 and 122 serve to support one communication protocol or two or more communication protocols, and for example, they support at least some of communication protocols such as TCP/IP, IPX, SPX, NetBIOS, Ethernet, ARCNET, Fiber Distributed Data Interface (FDDI), IEEE 802.11, IEEE 802. 11a, and direct synchronization connection.

The input modules 113 and 123 serve to receive commands or data to be used in the components (e.g., the control modules 111 and 121) of the advertising platform management server 110 and/or the user terminal 120 from the outsides (e.g., a user such as a first user, a second user, and the like, and a manager of the advertising platform management server 110) of the advertising platform management server 110 and/or the user terminal 120. Further, the input modules 113 and 123 include touch recognition displays, touch pads, button recognition modules, voice recognition sensors, mikes, mouses, or keyboards disposed on the advertising platform management server 110, the user terminal 120, and/or an external server (not shown). In this case, the touch recognition displays, the touch pads, and the button recognition modules may recognize the touches occurring by the user’s body (e.g., fingers) by means of impact sensing and/or capacitive sensing.

The output modules 114 and 124 serve to display the signals (e.g., voice signals), information, data, images, and/or all kinds of objects that are produced by the control modules 111 and 121 or acquired by the communication modules 112 and 122 of the advertising platform management server 110 and/or the user terminal 120. For example, the output modules 114 and 124 include displays, screens, displaying units, speakers, and/or light emitting devices (e.g., LED lamps).

Further, the advertising platform management server 110 and/or the user terminal 120 include storage modules, and the storage modules serve to store basic programs, application programs, set information, and the like for operating the advertising platform management server 110 and/or the user terminal 120. Further, each storage module includes at least one of storage media such as flash memory type memory, hard disk type memory, multimedia card micro type memory, card type memory (e.g., SD or XD memory), magnetic memory, magnetic disk, optical disk, Random Access Memory (RAM), Static Random Access Memory (SRAM), Read-Only Memory (ROM), Programmable Read-Only Memory (PROM), and Electrically Erasable Programmable Read-Only Memory (EEPROM).

Further, the storage modules include personal information of the first user, the second user, the third user, and the fourth user, and the like that use the advertising platform management server 110 and/or the user terminal 120. The personal information includes names, identifiers (ID), passwords, resident registration numbers, addresses, telephone numbers, cellular phone numbers, and/or e-mail addresses, and the like. Further, the control modules 111 and 121 perform various operations by using all kinds of programs, contents, and data stored in the storage modules.

Like this, the storage modules serve to store and/or manage all kinds of data required to provide the advertising platform service. The storage modules store information of advertising costs by business, information of changes in sales according to advertisement duration, and the like.

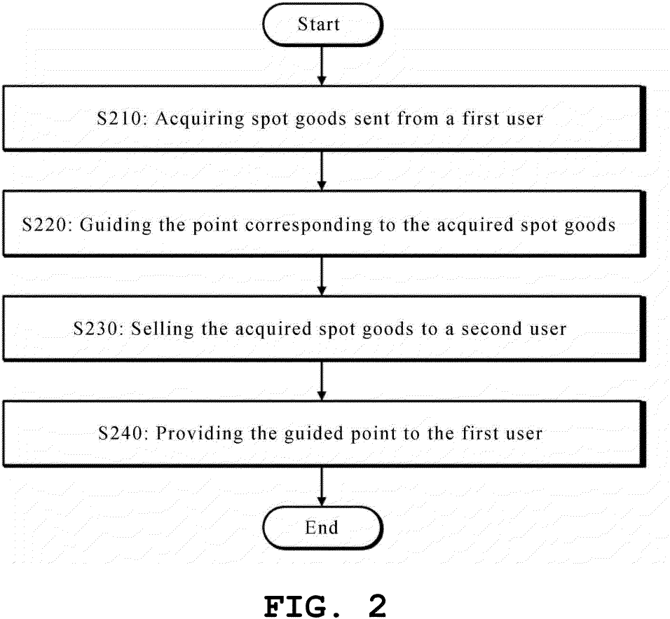

FIG. 2 is a flowchart showing a method for providing an advertising platform service according to an embodiment of the present invention.

Referring to FIG. 2, a method for providing an advertising platform service according to the embodiment of the present invention includes the step of acquiring spot goods sent from a first user (at step S210). Next, the method includes the step of guiding the point corresponding to the acquired spot goods (at step S220).

In this case, the spot goods are things, not money and include cars, bikes, bicycles, books, furniture, computers, cellular phones, electronic devices, tickets, travel vouchers, accommodation vouchers, cinema tickets, health supplements, household items, bath items, office items, stationary, home appliances, leisure items, products for babies, beauty products, fashion stuffs, and the like. Further, the spot goods may be goods purchased and used by the first user. Also, the spot goods may be called ‘donated objects’.

For example, the advertising platform management server 110 first outputs a spot goods list that can be exchanged with points, and if the spot goods are acquired, it produces and outputs the point corresponding to the spot goods acquired. The spot goods list (or called ‘spot goods list information’) includes information of the spot goods to which points can be applied and information of the points corresponding to the respective spot goods. The spot goods list information is outputted through the web page and/or application supporting the service according to the present invention, and otherwise, it may be provided to the first user.

For another example, if the advertising platform management server 110 obtains or receives the information of the spot goods acquired, it performs valuation based on the information of the spot goods, determines the point values based on the valuation, and produces and outputs the information of guiding the determined point values. The information of guiding the point values is outputted through the web page and/or application supporting the service according to the present invention, and otherwise, it may be provided to the first user.

In this case, the point values may be different according to initial sales prices of the spot goods, passing time after purchase, broken states of the spot goods, whether who is the first user, and the number of reservations (or call dibs or add to cart) in the web page and/or application supporting the service according to the present invention.

Further, the point values determined according to the performed valuation based on the information of the spot goods are called first addition points. Also, the point may be called repay.

Besides, the spot goods are transferred to a company that provides/supports the advertising platform service according to the present invention through a delivery service, and otherwise, they may be transferred to the company directly from the first user. If the spot goods arrive at the company or are received from the company, information indicating that the spot goods arrive (are received) is transmitted to the advertising platform management server 110 from a terminal of the manager or staff of the company.

According to the present invention, further, the first user acquires the first addition point on the condition where he or she provides given services (e.g., patent application service, moving service, cleaning service, karaoke service, leaflet distribution service, and the like). Hereinafter, characteristics of point acquisition and point addition and subtraction through the spot transaction will be applied to embodiments wherein points are acquired, added and subtracted on the condition where the given services are provided.

Next, the method includes the step of selling the acquired spot goods to a second user (at step S230).

For example, the transaction (buying and selling) of the spot goods is performed on-line, but it may be performed off-line.

If the spot goods are sold on-line, for example, the sales prices of the spot goods, the purchase of the spot goods, the order/delivery of the spot goods, and the like are performed through the web page and/or application supporting the service according to the present invention.

Contrarily, if the spot goods are sold off-line, information of the spot goods sold after the spot goods have been sold is transmitted to the advertising platform management server 110 from the terminal of the manager or staff.

After that, the method includes the step of providing the guided point to the first user (at step S240).

In this case, the steps S210 to S240 are sequentially performed, but of course, they may be changed in order. Further, only some of the steps S210 to S240 may be combined to another description of the present invention.

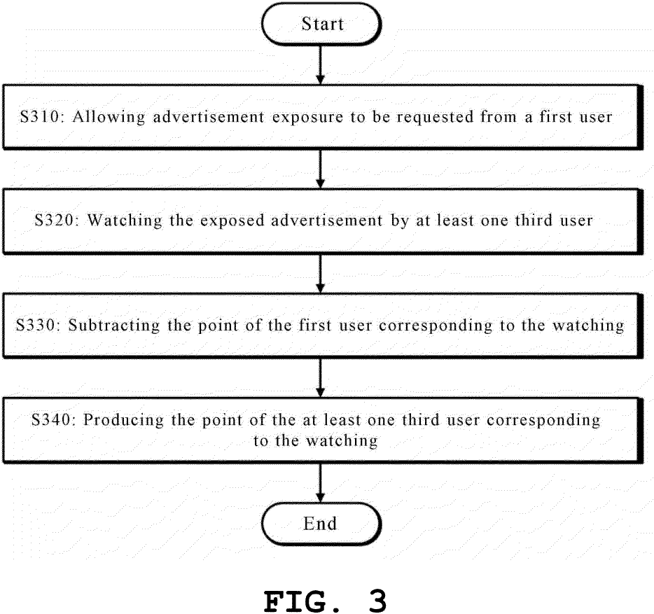

FIG. 3 is a flowchart showing a method for providing an advertising platform service according to another embodiment of the present invention.

Referring to FIG. 3, a method for providing an advertising platform service according to another embodiment of the present invention includes the step of allowing a first user to request advertisement exposure (at step S310).

For example, the first user requests an advertisement and/or advertisement exposure of the first user (individual), the group (e.g., group, corporation, and the like) of the first user, and the company, product, service, business model (BM), financial product, policy, and the like of the first user through a web page and/or application supporting the advertising platform service according to the present invention. The advertisement of the first user (individual), the group (e.g., group, corporation, and the like) of the first user, and the company, product, service, business model (BM), financial product, policy, and the like of the first user are hereinafter called the advertisement of the first user or the first user advertisement for the brevity of the description.

Further, the method includes the steps of watching the exposed advertisement by at least one third user (at step S320).

For example, the first user advertisement is exposed or outputted to the at least one third user through the web page and/or application supporting the advertising platform service according to the present invention.

For another example, the first user advertisement is exposed or outputted to the at least one third user through the web page and/or application connected to the advertising platform management server 110 and/or a web page and/or application operating by an external server (not shown) that receives the information of the advertisement.

For yet another example, the first user advertisement is exposed or outputted to a specific menu and/or object of the web page and/or application outputted from the terminal of the third user. In this case, the specific menu and/or object indicate my page, and the like.

Further, the advertising platform management server 110 acquires the time of the first user advertisement read by the at least one third user and the number of times the first user advertisement is read and stores the acquired information in the storage module. The time of the first user advertisement read by the at least one third user and the number of times the first user advertisement is read are determined by the advertising platform management server 110 according to the output of the page on which the first user advertisement is included through the terminal (third terminal) of the at least one third user or whether the first user advertisement is outputted even when page scrolling is stopped.

The number of times and/or time of the first user advertisement exposed/outputted to the at least one third user or the third terminal are limited to the number of given times and/or given time. This prevents the at least one third user from being exposed to indiscriminate advertisements.

Further, the first user advertisement is exposed/outputted to the at least one third user or the third terminal only while the terminal (the first terminal 120) of the first user is executing the web page and/or application providing/supporting the advertising platform service according to the present invention. This prevents the first point of the first user from being excessively subtracted due to the exposure of the first user advertisement over the number of times as desired by the first user.

Next, the method includes the step of subtracting the point of the first user corresponding to the watching of the at least one third user (at step S330). After that, the method includes the step of producing the point of the at least one third user corresponding to the watching (at step S340).

If the at least one third user watches the first user advertisement, for example, the advertising platform management server 110 subtracts a second subtraction point from the first point the first user holds and adds a second addition point to a third point the at least one third user holds.

Further, only in the case where the at least one third user watches the first user advertisement by reference time (or over the reference time or within the reference time range), the advertising platform management server 110 subtracts the second subtraction point from the first point the first user holds and adds the second addition point to the third point the at least one third user holds. In this case, the reference time and/or reference time range are set by the control module 111 of the advertising platform management server 110 and/or the control module 112 of the terminal 120. Further, considering only the case wherein the at least one third user watches the first user advertisement within the reference time range (for one hour or more or for two hours or less) through the advertising platform management server 110 may be necessary because, if the first user advertisement is exposed for relatively long hours, it may be left in a state where the screen outputting the first user advertisement is turned on, so that the third user does not watch the first user advertisement actually.

The second subtraction point may be set as a higher value than the second addition point. For example, if the at least one third user watches the first user advertisement one time, 80 points (that is, the second subtraction point) are subtracted from the first point the first user holds and 20 points (that is, the second addition point) are added to the third point the at least one third user holds. For another example, if the at least one third user watches the first user advertisement one time, 10 points (that is, the second subtraction point) are subtracted from the first point the first user holds and 10 points (that is, the second addition point) are added to the third point the at least one third user holds.

Besides, the third user purchases the spot goods, products, and the like (of the first user) or receives the service through the web page and/or application supporting the service according to the present invention by using the points acquired (accumulated) by watching the first user advertisement. Of course, further, the first user purchases the spot goods, products, and the like (of the first user) or receives the service through the web page and/or application supporting the service according to the present invention by using the first point.

The advertising platform management server 110 controls the first user advertisement so that the first user advertisement is exposed or outputted not to a plurality of unspecified terminals, but only to the third terminal that has a distance difference between information of the position of the third terminal among the at least one or more third terminals (of at least one or more third users) and information of a first position of the first terminal of the first user lower than a distance threshold value. Further, the acquisition of the first position information of the first terminal of the first user and the acquisition of the third position information of the third terminal of the third user are carried out periodically. At the time point when the spot goods of the first user are sold, the acquisition is carried out according to a first position information acquisition period, but if the spot goods sold by the first user do not exist, the acquisition is carried out according to a second position information acquisition period. In this case, the second position information acquisition period is set longer than the first position information acquisition period, and accordingly, if the firs user does not sell the spot goods to thus have a low probability in serving as an advertiser, energy resource waste through GPS position information acquisition is prevented and/or process allocation saving is obtained. The first position information and/or the third position information are acquired or received through a GPS module (not shown) and/or the communication module 112 of the advertising platform management server 110.

In this case, the steps S310 to S340 are sequentially performed, but of course, they may be changed in order. Further, only some of the steps S310 to S340 may be combined to another description of the present invention.

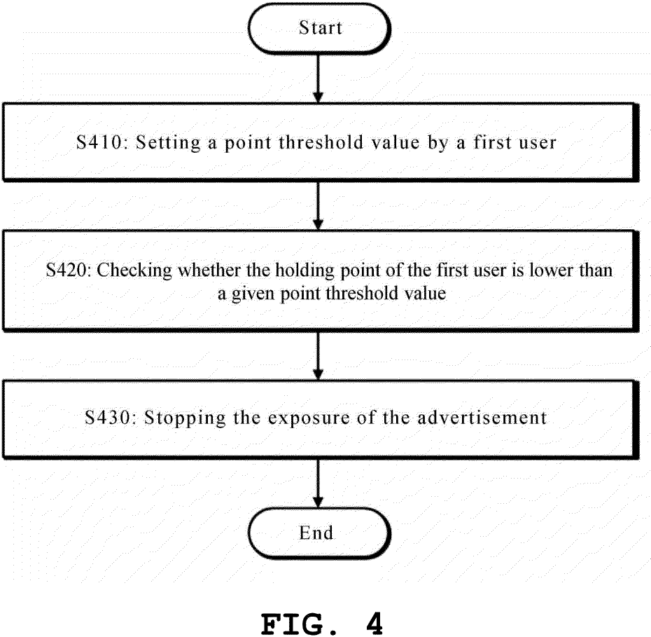

FIG. 4 is a flowchart showing a method for providing an advertising platform service according to yet another embodiment of the present invention.

Referring to FIG. 4, a method for providing an advertising platform service according to yet another embodiment of the present invention includes the step of setting a given point threshold value by a first user (at step S410) .

For example, the first user sets the given point threshold value through a web page and/or application supporting the advertising platform service according to the present invention. In this case, the point threshold value is a value arbitrarily set by the first user so as to prevent the point from being lower than the set value.

Further, the method includes the step of checking whether the point the first user holds is lower than the given point threshold value (at step S420). After that, the method includes the step of stopping the exposure of the advertisement (at step S430) .

As mentioned above, if at least one third user watches the first user advertisement, the second subtraction point is subtracted from the first point the first user holds.

Through such a process, the reduction of the first point of the first user to a specific value may occur, and if the reduced first point is lower than the point threshold value (that is, less than the point threshold value), the advertising platform management server 110 stops (drops) the exposure or output of the first user advertisement through the web page and/or application providing/supporting the advertising platform service according to the present invention.

In this case, the steps S410 to S430 are sequentially performed, but of course, they may be changed in order. Further, only some of the steps S410 to S430 may be combined to another description of the present invention.

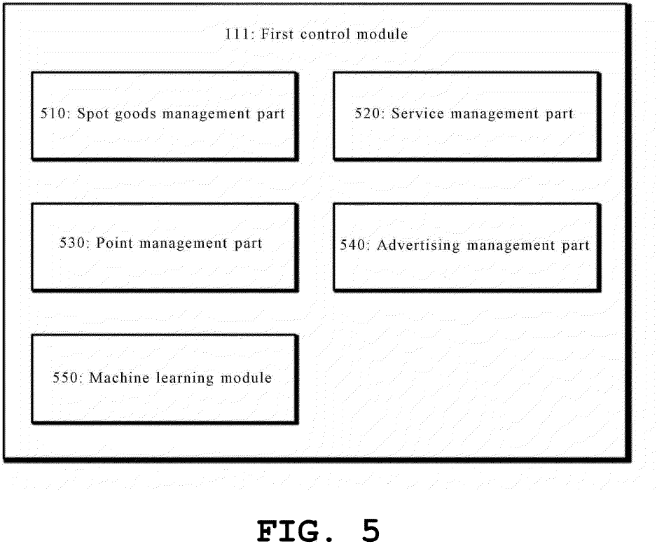

FIG. 5 is a block diagram showing the control module of the advertising platform management server according to the present invention.

Referring to FIG. 5, the control module 111 of the advertising platform management server 110 includes a spot goods management part 510, a service management part 520, a point management part 530, an advertising management part 540, and/or a machine learning module 560.

The spot goods management part 510 serves to manage the selling and buying of the spot goods as mentioned with reference to FIGS. 1 to 4, produce and output the spot goods list as mentioned above, and manage the information related to the storage of the spot goods.

The service management part 520 serves to manage the service provided by the first user and output the information related to the service through the web page and/or application supporting the service according to the present invention. Further, the service management part 520 is connected to the point management part 530 to produce or manage the point when the service is provided to another user.

The point management part 530 serves to produce, manage or set the first point, the second point, the first addition point, the first subtraction point, the second addition point, the second subtraction point, and the like, as mentioned with reference to FIGS. 1 to 4.

The advertising management part 540 serves to produce, recommend, and output the first user advertisement, as mentioned with reference to FIGS. 1 to 4.

The machine learning module 560 serves to set or determine the first subtraction point, the first addition point, the second subtraction point, the second addition point, the point threshold value, the reference time and/or the reference time range, based on an artificial neural network. Further, the machine learning module 560 serves to produce or determine the first subtraction point, the first addition point, the second subtraction point, the second addition point, the point threshold value, the reference time and/or the reference time range by using machine leaning of the big data stored in the database of the advertising platform management server 110. Besides, the machine learning module 560 serves to learn the artificial neural network with the input variable of the big data stored in the database of the advertising platform management server 110, and in specific, the machine learning module 560 serves to learn the artificial neural network to allow an accurate correlation to be derived by means of deep learning as a field of the machine learning.

In the case where there is the correlation, in specific, the input is data of the third point accumulated by the third user, the number of times the first user advertisement is watched and the watching time by the third user, a time difference between a time point when the spot goods are sold by the first user and a time point when the spot goods are purchased by the second user (or a difference between a first time point when the information of acquisition of the spot goods of the first user is acquired by the advertising platform management server 110 and a second time point when the spot goods are purchased and paid by the second user), and/or statistics of sales rate of the spot goods, and the output is defined as the data of the first subtraction point, the first addition point, the second subtraction point, the second addition point, the point threshold value, the reference time, and/or the reference time range.

For example, as the difference between the first time point when the information of acquisition of the spot goods of the first user is acquired by the advertising platform management server 110 and the second time point when the spot goods are purchased and paid by the second user becomes large, the machine learning module 560 sets (resets) the first addition point as a higher value than before.

For another example, as the total third point accumulated by the third user become large, the machine learning module 560 sets (resets) the second addition point as a lower value than before. Further, as the number of times the first user advertisement is watched or the watching time by the third user becomes larger or longer, the machine learning module 560 sets (resets) the second addition point as a lower value than before.

For yet another example, as the number of spot goods sold by the first user and/or the number of times of sales become larger, the machine learning module 560 sets (resets) the first addition point as a lower value than before and/or sets (resets) the second addition point as a lower value than before.

Further, the machine learning module 560 calculates weights of the above inputs of the functions through the deep learning. As artificial neural network models utilized for the learning, there are various models such as Recurrent Neural Network (RNN), Deep Neural Network (DNN), and/or Dynamic Recurrent Neural Network (DRNN).

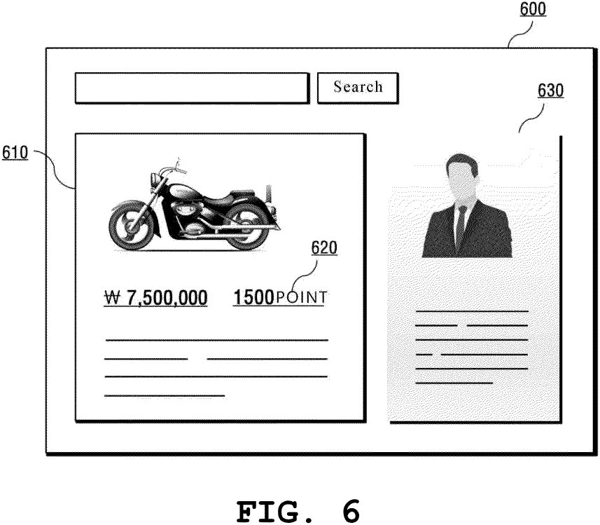

FIG. 6 is an exemplary view showing the web and/or application supporting the advertising platform service according to the present invention.

The web and/or application providing the advertising platform service according to the present invention outputs the page 600 of FIG. 6. For example, the page 600 includes a first page 610 and/or a second page 630.

For example, the first page 610 includes the information of the spot goods to which points are applied when sold, and for another example, the first page 610 includes the information of the spot goods sold by the first user. The first page 610 further includes the information of the point (e.g., the first addition point) corresponding to the spot goods, which is indicated by a reference numeral 620.

The spot goods included on the first page 610 are things, not money and include cars, bikes, bicycles, books, furniture, computers, cellular phones, electronic devices, tickets, travel vouchers, accommodation vouchers, cinema tickets, health supplements, household items, bath items, office items, stationary, home appliances, leisure items, products for babies, beauty products, fashion stuffs, and the like.

For example, the second page 630 may be the page on which the first user advertisement is included. In this case, the advertisement of the first user (that is, the first user advertisement) includes image and/or text information of the first user (individual), the group (e.g., group, corporation, and the like) of the first user, and the company, product, service, business model (BM), financial product, policy, and the like of the first user.

Like this, the method for providing the advertising platform service according to the present invention includes the steps of: receiving, by the server, information indicating that the spot goods sent from the first user have been obtained; producing and outputting, by the server, information guiding the first addition point corresponding to the spot goods; and allowing, by the server, the first addition point to be added to the first point of the first user if the spot goods are sold to a second user.

The server receives an advertisement request message for requesting the exposure of the first user advertisement of the first user from the first terminal of the first user and outputs the first user advertisement through at least one of the web and application operating by the server in response to the advertisement request message.

The first user advertisement is outputted through the third terminal of the at least one third user, and according to the number of first user advertisement outputs by the third terminal, the first point is subtracted, while the third point of the at least one third user is added.

According to the number of first user advertisement outputs by the third terminal, the first point is subtracted by the second subtraction point, the third point is added by the second addition point, and the second subtraction point is larger than the second addition point.

The point threshold value is set through the first terminal of the first user.

The method further includes the step of allowing the server to stop outputting the first user advertisement through the third terminal if the first point is lower than the point threshold value.

The first user advertisement represents the first user, the group of the first user, the company operating by the first user, the sales products of the first user, and the services provided by the first user.

The system for providing the advertising platform service according to the present invention includes the server for managing the advertising platform for providing the advertising platform service and having the control module and the communication module, wherein the control module receives information indicating that the spot goods sent from the first user have been obtained, produces and outputs information guiding the first addition point corresponding to the spot goods, and allows the first addition point to be added to the first point of the first user if the spot goods are sold to the second user.

The communication module receives the advertisement request message for requesting the exposure of the first user advertisement of the first user from the first terminal of the first user and outputs the first user advertisement through at least one of the web and application operating by the server in response to the advertisement request message.

The first user advertisement is outputted through the third terminal of the at least one third user, and according to the numbers of first user advertisement outputs by the third terminal, the first point is subtracted, while the third point of the at least one third user is added.

The point threshold value is set through the first terminal of the first user, and the control module stops outputting the first user advertisement through the third terminal if the first point is lower than the point threshold value.

The preferred embodiments of the present invention have been disclosed in the specification and drawings, as the specific exemplary embodiments through which the technical scope of the present invention can be easily understood, not as those for limiting the scope of the present invention. That is, other embodiments of the present invention will be apparent to those skilled in the art from consideration of the specification and practice of the present invention disclosed here. Further, the respective embodiments of the present invention may combinedly operate if necessary. For example, some of all embodiments of the present invention may be combined to one another and implemented by the advertising platform service system 100, the advertising platform management server 110, the user terminal 120, and/or another user terminal 130.

Moreover, the method for controlling the advertising platform service system 100, the advertising platform management server 110, the user terminal 120, and/or another user terminal 130 is implemented to the form of program commands that are executable through various computer means and recorded in a computer readable recording medium.

Like this, the various embodiments of the present invention are implemented as the computer readable codes in the computer readable recording medium. The computer readable recording medium is an arbitrary data storage device for storing data readable by a computer system. The computer readable recording medium may include Read-Only Memory (ROM), Random Access Memory (RAM), Compact Disk-Read Only Memory (CD-ROM), magnetic tape, floppy disk, optical data storage device, and carrier wave (data transmission through internet). The computer readable recording medium may be distributed through computer systems connected through networks, and accordingly, the computer readable codes may be stored and executed in the distributed manner. Further, the functional programs, codes, and code segments for achieving the various embodiments of the present invention may be easily analyzed by the programmers skilled in the art.

Further, the device and method according to the embodiments of the present invention may be implemented by hardware, software, and /or any combination thereof. For example, the software may be stored in a storage medium that can be optically or magnetically recorded and read by a machine (e.g., computer), such as volatile or non-volatile storage device, e.g., ROM, memory, e.g., RAM, memory chip, device, or integrated circuit, compact disk (CD), DVD, magnetic disk or magnetic tape, and the like, irrespective of whether deletion is possible or rewriting is possible. The methods according to the embodiments of the present invention may be carried out through a computer or a portable terminal having the control modules 111 and 121 and the memory, and the memory is an example of the storage medium readable by a machine that stores the program or programs with the commands for implementing the embodiments of the present invention.

Accordingly, the present invention may include a program having the code for implementing the device or method as defined in the claims of the present invention and a storage medium readable by a machine (computer and the like) for storing the program. Further, the program may be electronically transferred through an arbitrary medium such as a communication signal transmitted through wired or wireless connection, and the present invention may include the equivalents thereof appropriately.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

1. A method for providing an advertising platform service, comprising the steps of:
receiving, by a server, information indicating that the spot goods sent from a first user have been obtained;
producing and outputting, by the server, information guiding a first addition point corresponding to the spot goods; and
allowing, by the server, the first addition point to be added to a first point of the first user if the spot goods are sold to a second user.

2. The method according to claim 1, wherein the server receives an advertisement request message for requesting the exposure of a first user advertisement of the first user from a first terminal of the first user and outputs the first user advertisement through at least one of web and application operating by the server in response to the advertisement request message.

3. The method according to claim 2, wherein the first user advertisement is outputted through a third terminal of at least one third user, and according to the number of first user advertisement outputs by the third terminal, the first point is subtracted, while a third point of the at least one third user is added.

4. The method according to claim 3, wherein according to the number of first user advertisement outputs by the third terminal, the first point is subtracted by a second subtraction point, the third point is added by a second addition point, and the second subtraction point is larger than the second addition point.

5. The method according to claim 3, wherein through the first terminal of the first user, a point threshold value is set, and if the first point is lower than the point threshold value, outputting the first user advertisement through the third terminal is stopped by the server.

6. The method according to claim 2, wherein the first user advertisement represents the first user, the group of the first user, the company operating by the first user, the sales products of the first user, and the services provided by the first user.

7. A system for providing an advertising platform service, comprising a server for managing an advertising platform for providing the advertising platform service and having a control module and a communication module,
wherein the control module receives information indicating that the spot goods sent from a first user have been obtained, produces and outputs information guiding a first addition point corresponding to the spot goods, and allows the first addition point to be added to a first point of the first user if the spot goods are sold to a second user.

8. The system according to claim 7, wherein the communication module receives an advertisement request message for requesting the exposure of a first user advertisement of the first user from a first terminal of the first user and outputs the first user advertisement through at least one of web and application operating by the server in response to the advertisement request message.

9. The system according to claim 8, wherein the first user advertisement is outputted through a third terminal of at least one third user, and according to the number of first user advertisement outputs by the third terminal, the first point is subtracted, while a third point of the at least one third user is added.

10. The system according to claim 9, wherein through the first terminal of the first user, a point threshold value is set, and the control module stops outputting the first user advertisement through the third terminal if the first point is lower than the point threshold value.
